(19) United States
(12) Patent Application Publication
(10) Pub. No.: US 2007/0282817 A1
(43) Pub. Date: Dec. 6, 2007

(54) Plant information server, plant information processing method and plant information processing system

(75) Inventors: Susumu Okuno, Musashino-shi (JP); Naoyuki Okita, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/809,039

(22) Filed: May 31, 2007

(30) Foreign Application Priority Data
Jun. 1, 2006 (JP) 2006-153326

(51) Int. Cl. G06F 17/30

(52) U.S. Cl. 707/3

(57) ABSTRACT

A storage section stores plant information as an object to which attribute information is attached. An extraction section compares an extraction condition that is written by a query language and is received from a client with the attribute information to extract plant information that meets the extraction condition from the plant information stored in the storage section by using a query engine. An information list providing section provides an information list of the plant information extracted by the extraction section to the client.

This application claims foreign priority based on Japanese Patent application No. 2006-153326, filed June 1, 2006, the content of which is incorporated herein by reference in its entirety.

### BACKGROUND OF THE INVENTION

1. Field of the Invention

The present invention relates to a plant information server, a plant information processing method and a plant information processing system for extracting necessary plant information and providing the plant information to a client. More particularly, the present invention relates to a plant information server, a plant information processing method and a plant information processing system that can extract the plant information flexibly.

2. Description of the Related Art

Ordinarily, in a plant, as a device that makes it possible for a client to access necessary plant information, a plant information processing system is used.

FIG. 3 is a block diagram showing a structure of a processing system of a related art. In FIG. 3, in a plant information server 120, plant information necessary for plant operation is integrated and managed by being centralized. In the plant information server 120, the plant information is structured and respectively stored as an object.

In the plant operation, roles such as operation and maintenance, and persons such as operator and maintenance staff exist. During the operation, necessary information, that is, the objects, are different depending on the roles or the persons. Therefore, in a client, a list table in which the necessary plant information is defined for each of the roles or the persons is stored.

For instance, in FIG. 3, in a terminal device 111 for an operator, a group of list tables 114 that defines the plant information necessary for the operator is stored. In a terminal device 112 for a maintenance staff, a group of list tables 115 that defines the plant information necessary for the maintenance staff is stored. The operator selects a suitable table from the group of the list tables 114 and requests for an access to the plant information server 120 with the selected table via the terminal device 111 so as to obtain the plant information defined in the table. Similarly, the maintenance staff selects a table from the group of the list tables 115 and requests for an access to the plant server 120 with the selected table via the terminal device 112 so as to obtain the plant information defined in the table.

JP-A-2001-195122 discloses an apparatus that accumulates event information or the like extracted from a controller for controlling a plant and analyzes the event information.

However, in the plant information processing system of the related art, the groups of the list tables corresponding to the roles or the persons need to be prepared for all the clients. Thus, when the number of the clients is increased, an engineering operation becomes enormous. Further, when there is a change in a plant facility, a troublesome work is necessary for correcting not only the plant information server but also the data of the groups of the list tables. Further, since the plant information defined by the group of the list tables needs to precisely describe the object to be used, a work for preparing and correcting the list table is troublesome, and it is not possible to flexibly respond to the change or the like of the plant facility.

### SUMMARY OF THE INVENTION

The present invention has been made in view of the above circumstances, and provides a plant information server, a plant information processing method and a plant information processing system that can extract necessary plant information flexibly without requiring a troublesome work.

In some implementations, a plant information server of the invention, comprising:

a storage section for storing plant information as an object to which attribute information is attached;

an extraction section for comparing an extraction condition that is written by a query language and is received from a client, with the attribute information, and extracting plant information that meets the extraction condition from the plant information stored in the storage section by using a query engine;

an information list providing section for providing an information list of the plant information extracted by the extraction section, to the client; and

a plant information providing section for obtaining plant information selected by the client from the information list, from the plant information stored in the storage section, and providing the obtained plant information to the client.

In the plant information server, the extraction condition is an ambiguous condition.

In the plant information server, the extraction condition is set by a user of the client.

The plant information server further comprising:

an attribute information setting accepting section for accepting setting of the attribute information attached to the object by a user.

In some implementations, a plant information processing method of the invention, comprising:

storing plant information as an object to which attribute information is attached;

comparing an extraction condition that is written by a query language and is received from a client, with the attribute information, and extracting plant information that meets the extraction condition from the stored plant information by using a query engine;

providing an information list of the extracted plant information to the client; and

obtaining plant information selected by the client from the information list, from the stored plant information, and providing the obtained plant information to the client.

In the plant information processing method, the extraction condition is an ambiguous condition.

The plant information processing method, further comprising:

accepting setting of the extraction condition by a user.

The plant information processing method, further comprising:

accepting setting of the attribute information attached to the object by a user.

In some implementations, a plant information processing system of the invention, comprising:

a client for requesting extraction of plant information based on an extraction condition that is written by a query language, and selecting plant information from an information list; and

a plant information server,

wherein the plant information server includes:

a storage section for storing plant information as an object to which attribute information is attached;

an extraction section for comparing the extraction condition received from the client with the attribute information, and extracting the plant information that meets the extraction condition from the plant information stored in the storage section by using a query engine;

an information list providing section for providing the information list of the plant information extracted by the extraction section, to the client; and

a plant information providing section for obtaining the plant information selected by the client from the information list, from the plant information stored in the storage section, and providing the obtained plant information to the client.

### BRIEF DESCRIPTION OF THE DRAWINGS

FIG. 1 is a block diagram showing a structure of a plant information processing system according to an embodiment of the invention.

FIGS. 2A and 2B are flowcharts each showing an operation procedure of a plant information server.

FIG. 3 is a block diagram showing a structure of a plant information processing system of a related art.

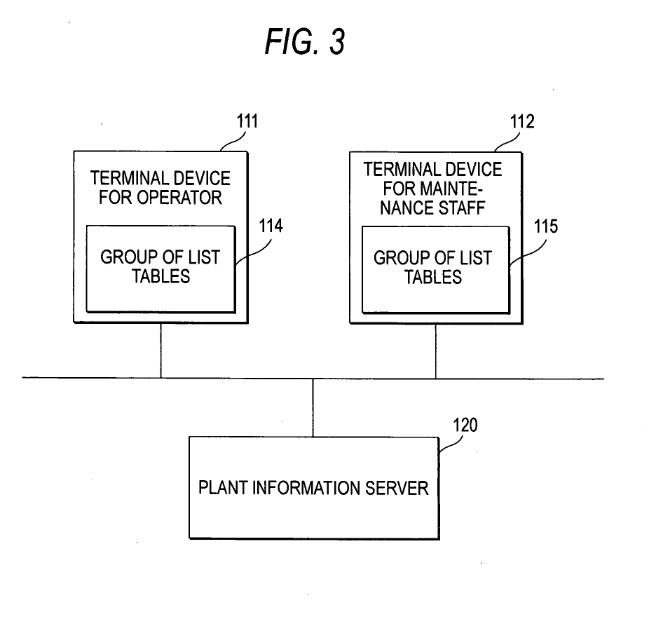

### DESCRIPTION OF THE PREFERRED EMBODIMENTS

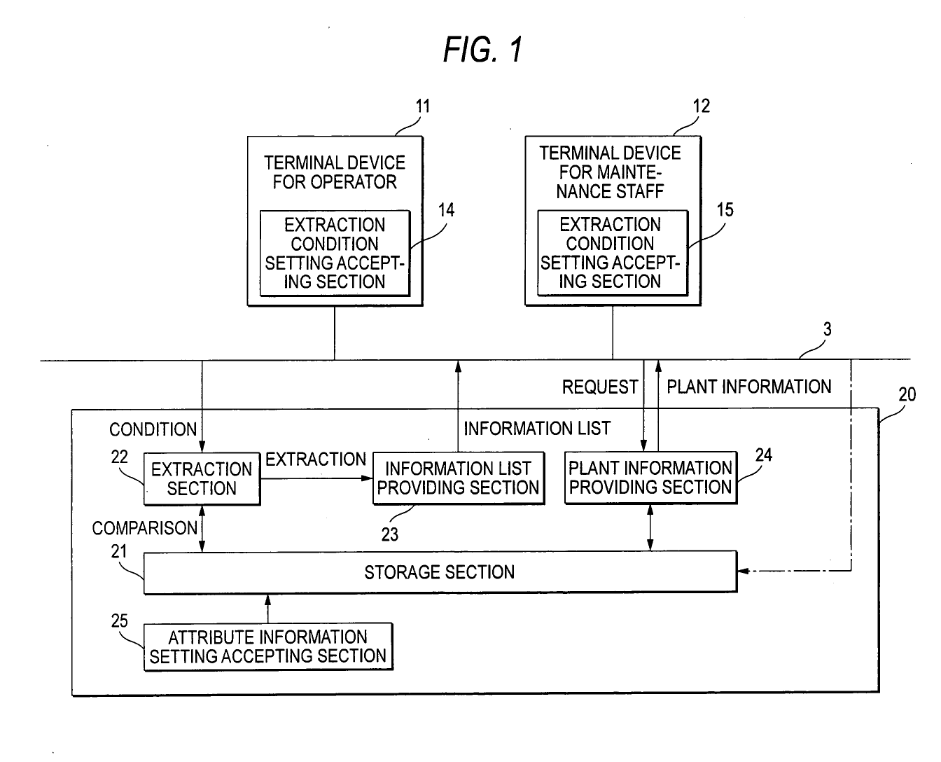

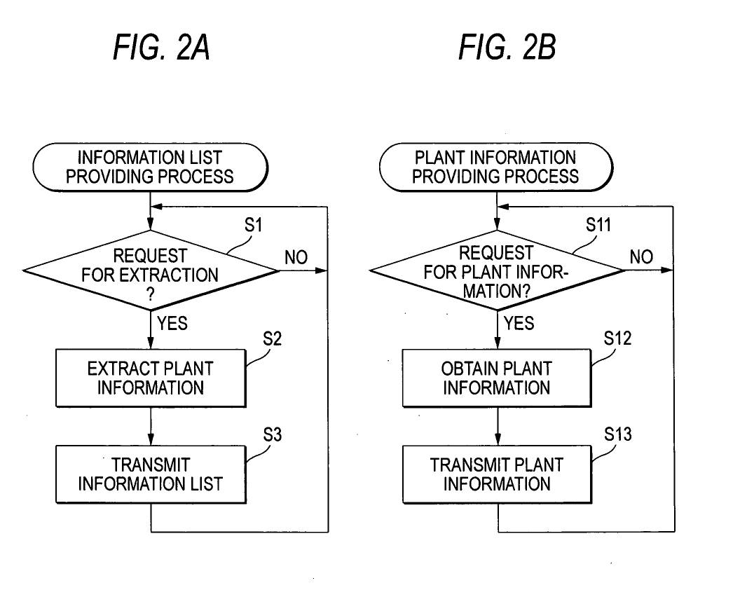

Now, referring to FIGS. 1, 2A and 2B, an embodiment of a plant information processing system according to the present invention will be described below.

FIG. 1 is a block diagram showing the structure of the plant information processing system of this embodiment.

As shown in FIG. 1, the plant information processing system includes a terminal device 11 and a terminal device 12 as clients for requesting plant information, and a plant information server 20 for accumulating the plant information. The terminal device 11 and the terminal device 12 and the plant information server 20 are connected to each other by a communication line 3.

As shown in FIG. 1, the plant information server 20 includes: a storage section 21 for storing the plant information as an object to which attribute information is attached; an extraction section 22 for comparing an extraction condition that is written by a query language and is received from the client, with the attribute information, to extract plant information that meets the extraction condition from the plant information stored in the storage section 21 by using a query engine; an information list providing section 23 for providing an information list of the plant information extracted by the extraction section 22 to the client; a plant information providing section 24 for obtaining plant information selected by the client from the information list, from the storage section 21, and providing the obtained plant information to the client; and an attribute information setting accepting section 25 for accepting setting of the attribute information attached to the object by a user.

Further, the terminal device 11 includes an extraction condition setting accepting section 14 for accepting setting of the extraction condition written by the query language by the user, and the terminal device 12 includes an extraction condition setting accepting section 15 for accepting setting of the extraction condition written by the query language by the user, respectively.

To the object stored in the storage section 21, the attribute information can be attached. The attribute information indicates an attribute of corresponding plant information. For instance, a role or a person, a type of a device, an installation area, a kind of process data (flow rate, temperature, etc.), an arbitrary keyword, etc., of which access to the plant information is permitted can be employed as the attribute information. A user of the plant information processing system can freely set and change the attribute information of each object through the attribute information setting accepting section 25.

On the other hand, a user can obtain necessary plant information from the plant information server 20 through the terminal device 11 and the terminal device 12 as the clients by using the query language. In a query statement sent from the client, the extraction condition necessary for extracting the plant information is described, and the plant information server 20 extracts the plant information that meets the extraction condition.

As the query language, for instance, an SQL (Structured Query Language) statement can be used. In this case, an ambiguous condition can be defined in a WHERE phrase. In this embodiment, since an ambiguous description is permitted in the extraction condition, the necessary plant information can be obtained by a simple definition as described later.

The query statement can be previously registered in each client. For instance, since the terminal device 11 is a device for the operator operating the plant, the query statement for extracting the plant information necessary for the operator is previously registered. The query statement registered in the terminal device 11 can be freely registered and changed by the user through the extraction condition setting accepting section 14. Further, the operator can prepare and use a new query statement through the extraction condition setting accepting section 14. Similarly, since the terminal device 12 is a device for the maintenance staff managing the plant, the query statement for extracting the plant information necessary for the maintenance staff is previously registered. The query statement registered in the terminal device 12 can be freely registered and changed by the user through the extraction condition setting accepting section 15. Further, the maintenance staff can prepare and use a new query statement through the extraction condition setting accepting section 15.

Next, an operation of the plant information processing system of this embodiment will be described below.

FIGS. 2A and 2B show flowcharts illustrating an operation procedure of the plant information server 20.

Step S1 to step S3 in FIG. 2A show processes for providing the information list to the client.

In the step S1 of FIG. 2A, it is determined whether or not a request for extracting the plant information is received from the client. Then, affirmation of the determination is waited, and the process goes to the step S2.

Here, for instance, the operator of the plant sends the query statement registered in the terminal device 11 or the newly prepared query statement to the plant information server 20 via the terminal device 11. When the plant information server 20 receives the query statement, the determination of the step S1 is affirmed.

In the step S2, the plant information is extracted by the extraction section 22 having the query engine. The extraction section 22 compares the extraction condition that is written by the query language and is received from the client, with the attribute information of the object stored in the storage section 21 by using the query engine, and extracts the plant information that meets the extraction condition from the storage section 21.

Then, in the step S3, the information list of the plant information extracted in the step S2 is received from the extraction section 22 by the information list providing section 23, and sent to the client, for instance, the terminal device 11. The information list is, for instance, a list of IDs uniquely assigned to the plant information respectively. After the process of the step S3 is completed, the process returns to the step S1.

The operator who has received the information list via the client, for instance, the terminal device 11, can select all the plant information included in the information list or arbitrary plant information from the information list, and request for an access to the selected plant information to the plant information server 20. Otherwise, the operator can request for further narrowing of the plant information by the query statement or request for extraction by a new extraction condition, obtain the information list, and then, request for an access to the plant information to the plant information server 20 by using the information list. A request for the access is carried out, for instance, by sending to the plant information server 20 the ID for specifying the plant information that the operator requests to access.

Step S11 to step S13 in FIG. 2B show processes for providing to the client the plant information that is requested to access.

In the step S11 of FIG. 2, it is determined whether or not the provision of the plant information is requested. Then, affirmation of the determination is waited, and the process goes to the step S12.

Here, for instance, the operator of the plant requests for the access to the plant information by using the ID to the plant information server 20 via the terminal device 11. When the plant information server 20 receives the request for access, the determination of the step S11 is affirmed.

In the step S12, a value of the plant information that is requested to access is obtained from the storage section 21 by the plant information providing section 24. Then, in the step S13, the obtained value of the plant information is transmitted to the client by the plant information providing section 24. The operator can know the value of the necessary plant information through the client that obtains the value of the plant information, for instance, the terminal device 11.

As described above, in the plant information processing system of this embodiment, since the extraction condition of the plant information is determined by the definition using the query language, the ambiguous extraction condition can be set, so that the name of the object does not need to be precisely designated, which is different from the related art. Accordingly, the extraction condition for extracting the necessary information according to the role or the person such as the operator and the maintenance staff can be extremely easily set to readily respond to the increase of an amount of information in the plant.

For instance, if a “maintenance staff” meaning that accesses of all the maintenance staffs are permitted is stored as the attribute information of the object, even when a “maintenance staff X,” which is the name of a specific maintenance staff, is designated as the extraction condition, the plant information corresponding to the object is extracted and included in the information list. In such a way, dynamic plant information extraction according to the role or the right of a user, or the person is possible by using the attribute information.

Further, for instance, if a “pump A,” which is the name of a specific device, is stored as the attribute information of the object, even when a “pump,” which is the name of a device, is designated as the extraction condition, the plant information corresponding to the “pump A” is also extracted as the object that meets the extraction condition.

Further, the installation area, etc., of the device can be used as the attribute information. For instance, if an “area A” is stored as the attribute information of the object, for instance, when the “maintenance staff X” and the “area A” are designated as the extraction condition, the information list of the facilities of maintenance objects existing in the area A can be obtained.

Further, since the attribute information can be set pluralistically, the plant information can be extracted from various viewpoints depending on methods for designating the extraction condition.

Further, according to the plant information processing system of this embodiment, flexible response to the change of the facility of the plant is possible without requiring a troublesome work. For instance, when the query statement meaning a “list of facilities of area A” is registered as the query statement held in the client, if the facility is added, removed or changed in the area A, only the data update of the storage section 21 is required. Thus, an engineering operation for correcting the client is not necessary. Even when the facility is added, removed or changed in the area A, if the “list of facilities of area A” is used as the extraction condition, correct information list can be obtained from the first. Therefore, inconveniences such that it takes much time for the engineering operation or a necessary engineering operation is forgotten can be avoided.

Further, according to the plant information processing system of this embodiment, since the user can freely set the extraction condition and the attribute information by using the extraction condition setting accepting sections 14 and 15 and the attribute information setting accepting section 25, a system that the user can easily make use of can be easily formed, and it is possible to respond to the change of the facility in the plant flexibly.

In the plant information processing system of this embodiment, various states of the objects can be included in the object as the attribute information. For instance, “under maintenance” is indicated as the attribute information as the state of the object, the information list of the plant information can be obtained by using, for instance, a “list of facilities under maintenance” as the extraction condition.

As described above, according to the plant information processing system of the present invention, since the plant information that meets the extraction condition is extracted from the plant information stored in the storage section by using the query engine, and the information list of the plant information is provided to the client, the plant information can be flexibly extracted and provided to the client. The extraction condition for extracting the necessary information according to the role or the person can be easily set, and it is possible to respond to the increase of the amount of information in the plant.

According to the plant information server of the present invention, since the plant information that meets the extraction condition is extracted from the plant information stored in the storage section by using the query engine, and the information list of the plant information is provided to the client, the plant information can be flexibly extracted and provided to the client.

According to the plant information processing method and the plant information processing system of the present invention, since the plant information that meets the extraction condition is extracted from the stored plant information by using the query engine, and the information list of the plant information is provided to the client, the plant information can be flexibly extracted and provided to the client.

An applied range of the present invention is not limited to the above-described embodiment. The present invention can be widely applied to a plant information server, a plant information processing method and a plant information processing system for extracting necessary plant information and providing the plant information to the client.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A plant information server, comprising:
a storage section for storing plant information as an object to which attribute information is attached;
an extraction section for comparing an extraction condition that is written by a query language and is received from a client, with the attribute information, and extracting plant information that meets the extraction condition from the plant information stored in the storage section by using a query engine;
an information list providing section for providing an information list of the plant information extracted by the extraction section, to the client; and
a plant information providing section for obtaining plant information selected by the client from the information list, from the plant information stored in the storage section, and providing the obtained plant information to the client.

2. The plant information server according to claim 1, wherein the extraction condition is an ambiguous condition.

3. The plant information server according to claim 1, wherein the extraction condition is set by a user of the client.

4. The plant information server according to claim 1, further comprising:
an attribute information setting accepting section for accepting setting of the attribute information attached to the object by a user.

5. A plant information processing method, comprising:
storing plant information as an object to which attribute information is attached;
comparing an extraction condition that is written by a query language and is received from a client, with the attribute information, and extracting plant information that meets the extraction condition from the stored plant information by using a query engine;
providing an information list of the extracted plant information to the client; and
obtaining plant information selected by the client from the information list, from the stored plant information, and providing the obtained plant information to the client.

6. The plant information processing method according to claim 5, wherein the extraction condition is an ambiguous condition.

7. The plant information processing method according to claim 5, further comprising:
accepting setting of the extraction condition by a user.

8. The plant information processing method according to claim 5, further comprising:
accepting setting of the attribute information attached to the object by a user.

9. A plant information processing system, comprising:
a client for requesting extraction of plant information based on an extraction condition that is written by a query language, and selecting plant information from an information list; and
a plant information server,
wherein the plant information server includes:
a storage section for storing plant information as an object to which attribute information is attached;
an extraction section for comparing the extraction condition received from the client with the attribute information, and extracting the plant information that meets the extraction condition from the plant information stored in the storage section by using a query engine;
an information list providing section for providing the information list of the plant information extracted by the extraction section, to the client; and
a plant information providing section for obtaining the plant information selected by the client from the information list, from the plant information stored in the storage section, and providing the obtained plant information to the client.

10. The plant information processing system according to claim 9, wherein the extraction condition is an ambiguous condition.

11. The plant information processing system according to claim 9, wherein the client includes an extraction condition setting accepting section for accepting setting of the extraction condition by a user.

12. The plant information processing system according to claim 9, wherein the plant information server includes an attribute information setting accepting section for accepting setting of the attribute information attached to the object by a user.
